(19) United States
(12) Patent Application Publication
(10) Pub. No.: US 2017/0270570 A1
(43) Pub. Date: Sep. 21, 2017

(54) GENERATING OFFERINGS FOR A GEOGRAPHIC LOCATION USING REFERRER INFORMATION

(71) Applicant: Google Inc., Mountain view, CA (US)

(72) Inventors: Arnold BINAS, Kirribilli (AU); Jordan John BAYLISS-MCCULLOCH, Pyrmont (AU); Michael Steven PERROW, Pyrmont (AU)

(21) Appl. No.: 13/691,701

(22) Filed: Nov. 30, 2012

(51) Int. Cl. G06Q 30/02; G06Q 10/08

(52) U.S. Cl. CPC G06Q 30/0277

(57) ABSTRACT

A system and method is disclosed for generating offerings for a geographic location using referrer information. A batch process may scan a group of information sources that display a point of interest to extract meta information related to the point of interest. In response to a current online display of the point of interest, one or more offerings based on the meta information may be determined and provided for display in connection with the current online display of the point of interest.

### TECHNICAL FIELD

The subject technology relates generally to the display of online advertising, namely systems for displaying advertisements on webpages.

### BACKGROUND

Webpages may be integrated with an interactive internet map that provides a user with the ability to view geographic information. An interactive map may be rendered within a computer-enabled interactive viewport that comprises a region of the display, and that functions to display a portion of the map at any one time.

### SUMMARY

The subject technology provides a system and method for associating marketing information with a displayed point of interest. According to one aspect, a computer-implemented method may include receiving, using one or more computing devices, one or more indications that one or more points of interest were displayed in connection with one or more information sources, determining, using the one or more computing devices, meta information from the one or more information sources, based on the received one or more indications, and, in response to a current online display of the one or more points of interest, determining, using the one or more computing devices, one or more offerings based on the meta information, and providing the one or more offerings for display in connection with the current online display of the one or more points of interest.

In another aspect, a machine-readable medium may have instructions stored thereon that, when executed, cause a machine to perform a method of generating offerings for a geographic location using referrer information. In this regard, the method may include receiving one or more indications that a geographic region of interest is associated with one or more webpages, determining first meta information from the one or more webpages associated with the geographic region of interest, based on the received one or more indications, storing the first meta information in a storage location organized by the geographic region of interest, and, in response to activity related to a current online display of the geographic region of interest, identifying the first meta information in the storage location based on the geographic region of interest, determining one or more offerings based on the first meta information, and providing the one or more offerings for display in connection with the current online display of the geographic region of interest.

In a further aspect, a system may include one or more processors and a memory. The memory may include instructions stored thereon that, when executed by the one or more processors, cause the one or more processors to receive one or more indications that a point of interest was displayed in connection with one or more webpages, analyze the one or more webpages to determine meta information based on the one or more webpages, based on the received one or more indications, determine one or more keywords or categories based on the determined meta information, and, in response to an indication that the point of interest was displayed at a current webpage, determine one or more offerings based on the keywords or categories, and provide the one or more offerings for display in connection with the display of the current webpage.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

A detailed description will be made with reference to the accompanying drawings:

FIG. 1 depicts an example webpage, displayed by a web browser, including an electronic map and one or more marketing components.

FIG. 2 is a diagram of an example system for providing a webpage hosted by a participating web server with internet offerings related to one or more geographic points of interest displayed on webpage.

FIG. 3 is a flowchart illustrating an example process for associating marketing information with a displayed point of interest.

FIG. 4 is a diagram illustrating an example computing system for associating marketing information with a displayed point of interest, including a processor and other internal components.

### DETAILED DESCRIPTION

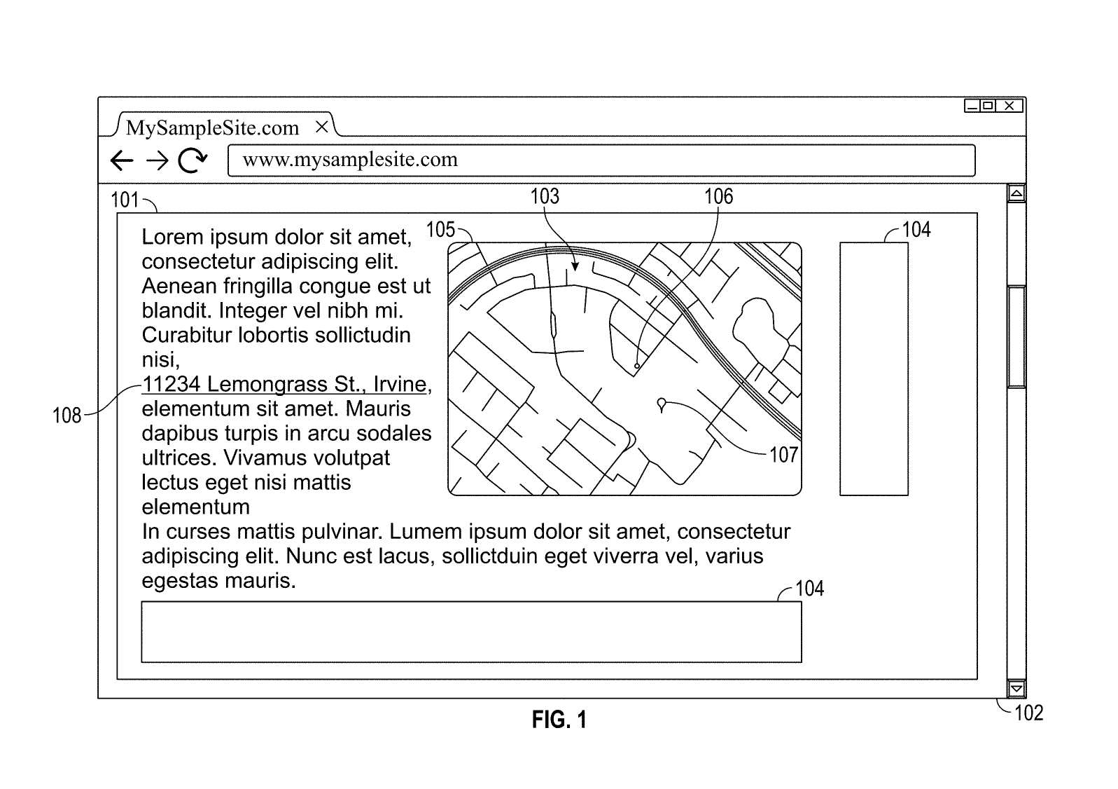

FIG. 1 depicts an example webpage 101, displayed by a web browser 102, including an electronic map 103 and one or more marketing components 104 according to one aspect of the subject technology. Electronic map 103 may displayed in a viewport 105, and may initially be fixed on a predetermined location, for example, at a geographic point of interest. The term “viewport” encompasses its plain and ordinary meaning, including, but not limited to, a rectangular geographic region of an electronic map that is visible at any one time, a section of programming instructions integrated with a webpage that, when executed by a web browser, displays a fraction of electronic map 103, and/or the like. The operations of viewport 105 or its associated electronic map 103 may be unrelated to other components (for example, marketing components 104) operating on the same webpage, or vice versa. In some aspects, electronic map 103 may be an interactive map or other interactive geographic representation capable of being repositioned by a user within viewport 105 in response to a panning, rotating, or zooming action (for example, with a mouse). In other aspects, the interactive map may be automatically repositioned. For example, electronic map 103 may be displayed on a GPS-enabled device (for example, a smart phone or navigation unit) that updates the map in real-time as the device is moved in three-dimensional space. While electronic map 103 is depicted as a two-dimensional map, electronic map may be any geographic representation, including, but not limited to, a three-dimensional interactive geographic representation (for example, a three-dimensional representation of the Earth or a geographically accurate virtual world).

A marketing component 104 displayed on webpage 101 may be generated from programming instructions (for example, JavaScript or other scripting code) embedded into the code of webpage 101. Each time the page is visited, the programming instructions may send information from webpage 101 via a series of procedural calls to a remote server to retrieve marketing content. The marketing content may include one or more offerings (for example, online advertisements, coupons, or the like) for display in connection with the currently displayed webpage 101. Information passed to the remote server to generate the marketing content may include certain keywords, for example, programmed by the creator of webpage 101 to describe the content of webpage 101, services provided by it, or an interaction with a user. Although electronic map 103 and marketing component 104 are shown as separate components, marketing component 104 may be integrated with electronic map 103 such that offerings are displayed within electronic map 103 (for example, proximate to points of interest related to the offerings).

As will be described in further detail, one or more offerings displayed by marketing component 104 may be based on content from webpage 101 and/or other webpages that referred users to webpage 101, or based on previous interactions of those users with electronic map 103. Offerings presented to a user may be further related to one or more points of interest displayed on electronic map 103, or narrowed by a displayed point of interest or other regions displayed on electronic map 103. For example, the displayed point of interest used may be determined based on a center point 106 of electronic map 103, a marker 107 set by the developer of webpage 101, a street address associated with a location (for example, a building) displayed within electronic map 103, an address 108 within content of webpage 101, and/or the like. I

On a display of the previously described point of interest (for example, on webpage 101 or within electronic map 103), stored meta information (for example, categories, keywords, and terms) pertaining to the displayed point of interest may be identified in a first storage location (for example, a database, database table, or the like) indexed by the point of interest, and used to retrieve (for example, look up, generate, or the like) one or more offerings related to the meta information from a second storage location. The one or more offerings may then be displayed, for example, within electronic map 103, or within marketing component 104, for example, proximate to the electronic map 103. On a user-repositioning of electronic map 103, the map may display a new point of interest, thereby updating the currently displayed offerings based on previously stored meta information associated with the new point of interest.

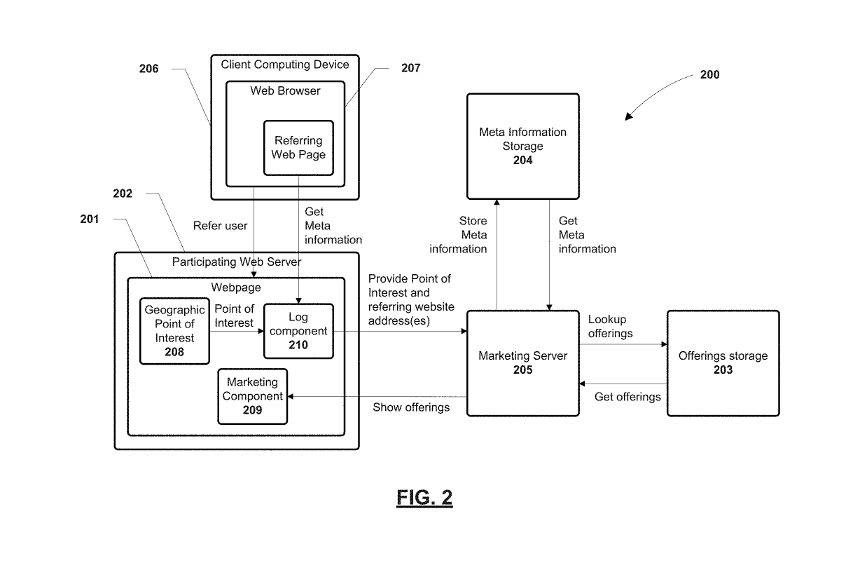

FIG. 2 is a diagram of an example system 200 for providing a webpage 201 hosted by a participating web server 202 with internet offerings related to one or more geographic points of interest displayed on webpage 201 according to one aspect of the subject technology. System 200 may include an offering storage 203 for storing a plurality of internet offerings, a meta-information storage 204 for storing meta-information corresponding to geographic locations, and a marketing server 205 for providing one or more offerings received from offering storage 203 to participating web server 202 based on a geographic indexing of meta-information storage 204. Participating web server 202 may be configured to provide webpage 201 to a client computing device 206 (for example a personal computer, tablet computer, PDA, Smartphone, a television or other display device with one or more computing devices embedded therein or attached thereto, or the like) for display in a web browser 207. Webpage 201 may include the display of one or more geographic points of interest 208 (for example, an address, location on, or related to, a displayed electronic map 103) and one or more marketing components 209 for the dynamic display of one or more offerings to a user viewing webpage 201. In one example, multiple geographic points of interest may be designated by markers on an electronic map. In some instances where one or more geographic points of interest 208 are displayed in, or as part of, an electronic map, the electronic map and marketing components 209 may be integrated to display offerings proximate the one or more geographic points of interest.

A log component 210 may be provided to webpage 201 as code embedded within webpage 201 or as a separate component (for example, Java object) that interacts with webpage 201 (for example, using procedural calls between webpage 201 and log component 210). Where log component 210 is a separate component, it may be implemented either on participating web server 202, may be downloaded as a web component (for example, from marketing server 205) in connection with the execution of instructions embedded in webpage 201 to be executed by web browser 207 or client computing device 206, or the like. Log component 210 may be configured to, on a display of webpage 201 (for example, in web browser 207), provide an indication to marketing server 205 that the one or more geographic points of interest 208 displayed by webpage 201 were displayed.

In other aspects, log component 210 may receive a representation of a geographic point of interest 208 from, for example, webpage 201 or an electronic map on webpage 201, and transmit the representation of geographic point of interest 208 to marketing server 205 when webpage 201 is displayed by web browser 207. Where geographic point of interest 208 is a character-based address, log component 210 may analyze (for example, scan) webpage 201 to determine geographic point of interest 208 from text or mark-up language used to create webpage 201. The analysis may be performed on a loading and execution of webpage 201 in web browser 207, or, in cases where log component 210 is a separate component, the analysis may be performed periodically, at predetermined intervals.

When webpage 201 is requested by, and provided to, web browser 207, log component 201 may automatically determine one or more request characteristics, including information about client computing device 206 and web browser 207. For example, log component 201 may examine HTTP header fields provided with the originating HTTP request from web browser 207 to determine the referring webpage 211 (for example, HTTP referrer), an electronic address (for example, IP address) associated with referring client computing device 206 or referring webpage 211, and/or the like. The one or more determined request characteristics may then be provided to marketing server 205 in connection with geographic point of interest 208 when webpage 201 is displayed by web browser 207.

Marketing server 205 may be configured to provide offerings to one or more marketing components 209 displayed on webpage 201 based on one or more focusing signals, including, but not limited to, geographic point of interest 208 and the information received from log component 210. For example, on receiving geographic point of interest 208, marketing server may index meta-information storage 204 using a representation of geographic point of interest 208 to retrieve stored meta-information corresponding to geographic point of interest 208. The representation of geographic point of interest 208 may include an address, business name, landmark, latitude and longitude, GPS coordinates, Cartesian coordinates, map cell or tile, or the like, displayed on webpage 201, or corresponding to a displayed portion of an electronic map or other interactive geographic representation displayed on webpage 201. In some aspects, the representation of geographic point of interest 208 is determined by performing a lookup of predetermined locations corresponding to coordinate information received from an electronic map displayed on webpage 101. For example, a user may zoom or pan to a point of interest on an electronic map corresponding to a center point of the electronic map after the zooming or panning action. The displayed point of interest may be cross-referenced with a specific address or other location (for example, by marketing server 205) to obtain identifying information about the point of interest, and the identifying information used to index meta-information storage 204.

In one aspect, meta-information storage 204 may include one or more keywords and/or other terms, or groups of keywords and/or other terms, each stored in connection with a respective geographic location index. Each geographic location index may represent a pointer to the one or more keywords and/or other terms, or groups of keywords and/or other terms. Accordingly, marketing server 205 may receive geographic point of interest 208 and provide the point of interest as an index to meta-information storage 204 to retrieve meta-information corresponding to geographic point of interest 208. Marketing server 205 may then use the meta-information to perform a lookup of one or more offerings stored in offering storage 203 (using, for example, a search engine). The one or more offerings may then be retrieved from offering storage 203 and provided to one or more marketing components 209.

The meta information (for example, keywords, terms, and the like) stored in meta-information storage 204 may be derived from third-party information sources associated with the currently displayed geographic point of interest 208. Third-party information sources may include a website, domain, or interactive map currently displaying the geographic region of interest, or other websites, domains, or interactive maps linked to a display of the geographic region of interest. For example, meta information may include the previously described request characteristics derived from HTTP headers of referring webpage 211.

In some aspects, log component 210 may provide indications that the one or more geographic points of interest 208 displayed by webpage 201 were displayed in the form of a list. The list may provide an entry for each time the one or more geographic points of interest 208 were displayed. In some examples, log component 210 may provide marketing server 205 a list (for example, as a data log) of referring webpages 211 on an ongoing basis or over a predetermined period of time. A batch process may iterate through the list and, for each webpage represented therein, initiate an analysis of the webpage to determine meta information from the content of the webpage. The content (for example, text, links, graphics) of each referring webpage 211 may also be compared against common keywords and/or terms associated with specific categories (for example, parks and recreation, electronics, pets, or the like) to categorize each referring webpage 211.

In at least one example, geographic cell locations (for example, predetermined bounded areas on a map) may be mapped to corresponding referring webpages 211. The referring webpages 211 mapped to each specific cell location may then be categorized, and one or more categories and/or keywords determined and stored for each cell location. In response to a current online display of geographic point of interest 208, a corresponding cell location may be determined (for example, from coordinates received from viewport 105) and the associated categories and/or keywords retrieved. In some aspects, one or more common categories may be determined. Common keywords, terms, and/or categories determined for the webpages referring to geographic point of interest 208 may then be associated and stored in connection with geographic point of interest 208 in meta-information storage 204. Multiple lists generated from log components 210 associated with different webpages displaying the same geographic point of interest 208 may be aggregated. In this regard, meta information related to geographic point of interest 208 may be accumulated over time from multiple referring websites (and domains), and common traits, trends, categories, and other data discovered to more specifically characterize geographic point of interest 208 so that offerings displayed in connection with geographic point of interest 208 may better focus on users viewing geographic point of interest 208.

In another aspect, meta information may be collected from third-party information sources, including, for example, anonymous user information (for example, interests of anonymous users) stored on behalf of users who have viewed geographic point of interest 208. For example, one or more websites may place one or more persistent third-party cookies on web browser 207 to determine, over a period of time and without making a determination of the user's identity, websites visited by the user, browsing habits, and/or user interests (for example, a sport or area of shopping). The anonymous meta-information stored in the one or more cookies may then be submitted to log component 210 (for example, if participating server 202 is able to access the cookies). In one aspect, the user may authorize log component 210 to be associated with meta-information stored in a remote storage in connection with an online user account. In this regard, log component 210 may access the remote storage and retrieve the non-anonymous meta-information from the user account when the user visits webpage 101. Content and other information provided by these third-party information sources may be analyzed to generate focusing signals, or the previously described meta information, which then may be categorized and stored in meta-information storage 204, indexed by a corresponding geographic point of interest 208.

In some aspects, meta information stored in meta-information storage 204 may be comparatively weighted to determine which stored meta information is more relevant to the geographic region of interest, and/or to discard meta information not representative of the geographic region of interest. For example, meta-information generated from webpage 201 may be determined to be reliable based on how many people are looking at it. In this regard, meta-information generated from webpage 201 may be used only if webpage 201 has received more than a predetermined number of visits. Similarly, marketing server 205 may keep track of an amount of traffic to webpage 201 that originated from each referring webpage 211, and determine reliability based on that amount. For example, meta-information generated from a referring webpage 211 that referred users to webpage 201 more than a predetermined number of times (for example, one-thousand) may be considered to be more reliable than meta-information generated from a referring webpage 211 that referred users on only an occasion of times (for example, three or four). In some aspects, more than a predetermined number of referrals may automatically classify the referring webpage as reliable.

The meta information associated with any particular webpage (for example, webpage 201, other webpage displaying point of interest 208, or a referring webpage 211) may be assigned a normalized value based the amount of traffic associated with the webpage (for example, by dividing the amount of traffic from the webpage by a total or average amount of traffic from a sample pool of webpages). The greater the normalized value associated with a set of meta information (for example, from one information source), the more likely that the set of meta information is relevant to the geographic point of interest to which it refers. System 200 (for example, marketing server 205) may maintain a threshold value representative of a level of reliability usually associated with referring webpages or with webpages displaying geographic point of interest 208 (for example, above an average or a mean of the normalized values). If the normalized value exceeds the threshold (for example, exceeds the average or a standard deviation from the mean), then system 200 may infer that the associated meta information is relevant and/or reliable.

In addition to being weighted based on internet traffic, meta information may be weighted based on a number of other characteristics in the same manner, including, for example, how many unique information sources link to the display of the geographic region of interest, how diverse information associated with a referring source is from a current categorization of the stored meta information, manually selected information sources, and the like. System 200 may also look for common meta-information (for example, keywords, categories, and/or terms) between a predetermined sample number of referring webpages 211 and/or between multiple webpages 201 displaying the same geographic point of interest 208, and only retain meta-information from a currently analyzed webpage that is common with the predetermined sample. For example, meta information that originates from information sources not associated with the one or more common categories may be excluded from being used to determine keywords or otherwise determine the one or more offerings. Similarly, meta information derived from an information source (for example, webpage 201 or 211) may be weighted based on how many other information sources are linked to the information source. Likewise, system 200 may exclude referring webpages 211 and duplicate webpages 201 that do not have more than a predetermined amount of common meta-information (for example, above an average or a mean of a number of terms found to be in common between webpages).

Participating web server 202 and marketing server 205 and client computing device 206 may be connected to and/or communicate with each other via the Internet or a remote private LAN/WAN. Likewise, in one aspect, offering storage 203, meta-information storage 204, and marketing server 205 may be connected to and/or communicate with each other via the remote private LAN/WAN or Internet. In some aspects, the various connections between participating web server 202, offering storage 203, meta-information storage 204, marketing server 205, and client computing device 206, and/or the Internet or private LAN/WAN, may be made over a wired or wireless connection. In some aspects, the functionality of marketing server 205 and offering storage 203 and meta-information storage 204 may be implemented on the same physical server or distributed among a plurality of servers. Similarly, the functionality of offering storage 203 and meta-information storage 204 may be implemented in the same storage or distributed across a plurality of storages. Moreover, the storages may take any form such as relational databases, object-oriented databases, file structures, text-based records, or other forms of data repositories.

Participating web server 202 may be configured to communicate with a user interface (for example, a webpage 101 displayed in web browser 102) on client computing device 206. In this aspect, the user interface may be configured to (for example, in connection with viewing a webpage) display to a user an interactive geographic representation (for example, electronic map 103 or the like) received from a remote map server. Likewise, the user interface may also be configured to display one or more marketing components 104 for the display of one or more online offerings along a side of the interactive geographic representation, or to superimpose the offerings on the interactive map (for example, in the form of icons and/or text).

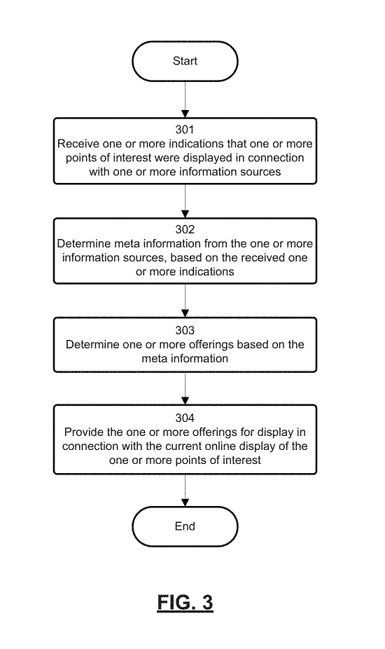

FIG. 3 is a flowchart illustrating an example process for associating marketing information with a displayed point of interest according to one aspect of the subject technology. In block 301, one or more indications that one or more points of interest were displayed in connection with one or more information sources are received. In some aspects, the one or more information sources may include one or more respective webpages responsible for the display of the one or more points of interest, or responsible for originating a request for the one or more webpages responsible for the display of the one or more points of interest. The indications are received by one or more computing devices, including, for example, marketing server 205. Each indication may be automatically sent by a respective webpage on a display of the webpage (for example, by a web browser). The one or more points of interest may include an address or location displayed on an electronic map, and

In block 302, meta information is determined from the one or more information sources, based on the received one or more indications. For example, after a series of indications are received, a batch process may analyze (for example, scan) the one or more webpages responsible for the display of the one or more points of interest to determine the meta information from content displayed by the one or more information sources (for example, text on a webpage). The batch process may be implemented as software running on the previously described one or more computing devices, including marketing server 205. The determined meta information may be stored in meta-information storage 204.

In response to a current online display of the one or more points of interest, in block 303, one or more offerings based on the meta information may be determined. In this regard, one or more keywords or categories related to the meta information may be determined, and then used to determine the one or more offerings, for example, by indexing a database or other storage location responsible for storing offerings by the keywords or categories. For example, marketing server 205 may lookup keywords or categories in meta-information storage 204 based on meta information embedded in a webpage 201 for the currently displayed one or more points of interest. Marketing server 205 may then query offerings storage 203 for offerings using the keywords or categories. In block 304, the one or more offerings are provided for display (for example, in web browser 207) in connection with the current online display of the one or more points of interest.

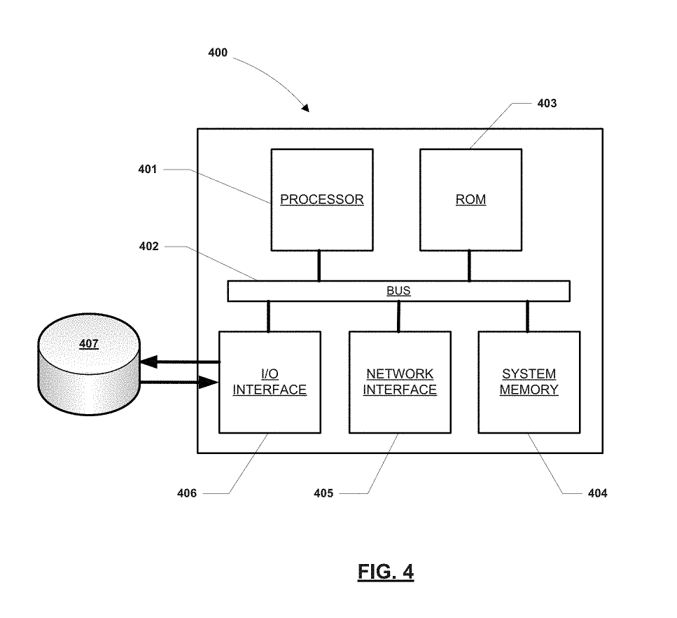

FIG. 4 is a diagram illustrating an example computing system for associating marketing information with a displayed point of interest, including a processor and other internal components, according to one aspect of the subject technology. In some aspects, a computerized device 400 (for example, participating web server 202, client device 206, marketing server 205, meta-information storage 204, offering server 203, or the like) includes several internal components such as a processor 401, a system bus 402, read-only memory 403, system memory 404, network interface 405, I/O interface 406, and the like. In one aspect, processor 401 may also be communication with a storage medium 407 (for example, a hard drive, database, or data cloud) via I/O interface 406. In some aspects, all of these elements of device 400 may be integrated into a single device. In other aspects, these elements may be configured as separate components.

Processor 401 may be configured to execute code or instructions to perform the operations and functionality described herein, manage request flow and address mappings, and to perform calculations and generate commands. Processor 401 is configured to monitor and control the operation of the components in server 400. The processor may be a general-purpose microprocessor, a microcontroller, a digital signal processor (DSP), an application specific integrated circuit (ASIC), a field programmable gate array (FPGA), a programmable logic device (PLD), a controller, a state machine, gated logic, discrete hardware components, or a combination of the foregoing. One or more sequences of instructions may be stored as firmware on a ROM within processor 401. Likewise, one or more sequences of instructions may be software stored and read from ROM 403, system memory 404, or received from a storage medium 407 (for example, via I/O interface 406). ROM 403, system memory 404, and storage medium 407 represent examples of machine or computer readable media on which instructions/code may be executable by processor 401. Machine or computer readable media may generally refer to any medium or media used to provide instructions to processor 401, including both volatile media, such as dynamic memory used for system memory 404 or for buffers within processor 401, and non-volatile media, such as electronic media, optical media, and magnetic media.

In some aspects, processor 401 is configured to communicate with one or more external devices (for example, via I/O interface 406). Processor 401 is further configured to read data stored in system memory 404 and/or storage medium 407 and to transfer the read data to the one or more external devices in response to a request from the one or more external devices. The read data may include one or more web pages and/or other software presentation to be rendered on the one or more external devices. The one or more external devices may include a computing system such as a personal computer, a server, a workstation, a laptop computer, PDA, smart phone, and the like.

In some aspects, system memory 404 represents volatile memory used to temporarily store data and information used to manage device 400. According to one aspect of the subject technology, system memory 404 is random access memory (RAM) such as double data rate (DDR) RAM. Other types of RAM also may be used to implement system memory 404. Memory 404 may be implemented using a single RAM module or multiple RAM modules. While system memory 404 is depicted as being part of device 400, those skilled in the art will recognize that system memory 404 may be separate from device 400 without departing from the scope of the subject technology. Alternatively, system memory 404 may be a non-volatile memory such as a magnetic disk, flash memory, peripheral SSD, and the like.

I/O interface 406 may be configured to be coupled to one or more external devices, to receive data from the one or more external devices and to send data to the one or more external devices. I/O interface 406 may include both electrical and physical connections for operably coupling I/O interface 406 to processor 401, for example, via the bus 402. I/O interface 406 is configured to communicate data, addresses, and control signals between the internal components attached to bus 402 (for example, processor 401) and one or more external devices (for example, a hard drive). I/O interface 406 may be configured to implement a standard interface, such as Serial-Attached SCSI (SAS), Fiber Channel interface, PCI Express (PCIe), SATA, USB, and the like. I/O interface 406 may be configured to implement only one interface. Alternatively, I/O interface 406 may be configured to implement multiple interfaces, which are individually selectable using a configuration parameter selected by a user or programmed at the time of assembly. I/O interface 406 may include one or more buffers for buffering transmissions between one or more external devices and bus 402 and/or the internal devices operably attached thereto.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

The term website, as used herein, may include any aspect of a website, including one or more web pages, one or more servers used to host or store web related content, and the like. Accordingly, the term website may be used interchangeably with the terms web page and server. The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

1. A computer-implemented method for associating marketing information with a displayed point of interest, the method comprising:
receiving, by one or more computing devices, one or more indications that one or more points of interest associated with a currently displayed webpage were previously displayed in connection with one or more information sources, the one or more information sources comprising one or more referring web pages associated with the one or more points of interest;
obtaining, by the one or more computing devices, meta information from the one or more information sources based on the received one or more indications, the meta information being determined based at least in part on an analysis of the one or more referring web pages; and
determining, by the one or more computing devices, one or more offerings based on the meta information, and providing the one or more offerings for display in connection with the one or more points of interest;
wherein the one or more offerings are determined based at least in part on a weight assigned to the meta information, the weight being determined based at least in part on an amount of internet traffic associated with the one or more information sources.

2. The computer-implemented method of claim 1, wherein the one or more points of interest are displayed by one or more webpages, and wherein the meta information is determined from content displayed by the one or more webpages.

3. The computer-implemented method of claim 2, wherein each point of interest is a location displayed in an electronic map, the electronic map being displayed by the one or more webpages.

4. The computer-implemented method of claim 2, wherein each point of interest is a character-based address displayed in connection with webpage content displayed by the one or more webpages.

5. The computer-implemented method of claim 1, further comprising:
identifying one or more keywords associated with the meta information; and
determining the one or more offerings by indexing a storage with the one or more keywords.

6. The computer-implemented method of claim 1, further comprising:
determining one or more referring addresses that originated a request for one or more webpages responsible for displaying the one or more points of interest; and
analyzing one or more respective referring webpages located at the one or more referring addresses to determine the meta information.

7. The computer-implemented method of claim 6, wherein the one or more respective referring webpages originated the request during a predetermined period of time.

8. The computer-implemented method of claim 1, wherein at least a portion of the meta information is determined from header information received in a request to view the current online display of the one or more points of interest.

9. The computer-implemented method of claim 1, wherein at least a portion of the meta information is determined from anonymous user information received from one or more cookies on a browser navigating to at least one of the one or more information sources.

10. The computer-implemented method of claim 1, wherein meta information derived from each of the one or more information sources is weighted based on a number of visits to a respective information source, and wherein only the meta information associated with information sources having over a predetermined number of visits is used to determine the one or more offerings.

11. The computer-implemented method of claim 1, further comprising:
determining one or more common categories based on the meta information from the one or more information sources; and
excluding meta information that originates from information sources not associated with the one or more common categories from being used to determine the one or more offerings.

12. The computer-implemented method of claim 1, wherein meta information derived from each of the one or more information sources is weighted based on how many other information sources are linked to the information source, and wherein only the meta information associated with information sources linked by a predetermined number of the other information sources is used to determine the one or more offerings.

13. The computer-implemented method of claim 1, wherein the one or more information sources comprise one or more respective webpages that display the one or more points of interest.

14. The computer-implemented method of claim 1, wherein the current online display of the one or more points of interest includes the one or more points of interest being displayed in a currently displayed portion of an interactive geographical representation.

15. A machine-readable medium having instructions stored thereon that, when executed, cause a machine to perform a method of associating marketing information with a displayed region of interest, the method comprising:
receiving one or more indications that a geographic region of interest is associated with one or more webpages;
determining first meta information from the one or more webpages associated with the geographic region of interest, based on the received one or more indications;
storing the first meta information in a storage location organized by the geographic region of interest; and
in response to activity related to a current online display of the geographic region of interest, identifying the first meta information in the storage location based on the geographic region of interest, determining one or more offerings based on the first meta information, and providing the one or more offerings for display in connection with the current online display of the geographic region of interest.

16. The machine-readable medium of claim 15, further comprising:
receiving second meta information based on a current online display of the geographic region of interest, wherein the one or more offerings are also determined based on the second meta information.

17. The machine-readable medium of claim 15, wherein the one or more webpages associated with the geographic region of interest include a webpage that originated a request for a webpage responsible for the current online display of the geographic region of interest.

18. The machine-readable medium of claim 15, wherein the one or more webpages associated with the geographic region of interest include one or more originating webpages that originated a request, during a predetermined period of time, for one or more webpages responsible for displaying the geographic regions of interest, the method further comprising:
analyzing the one or more originating webpages to determine the first meta information.

19. The machine-readable medium of claim 15, further comprising:
identifying one or more keywords associated with the first meta information; and
determining the one or more offerings based on indexing a storage of offerings using the one or more keywords.

20. A system, comprising:
one or more processors; and
a memory including instructions stored thereon that, when executed by the one or more processors, cause the one or more processors to:
receive one or more indications that a point of interest associated with a currently displayed first webpage was previously displayed in connection with one or more second webpages, the one or more second webpages being referring webpages associated with the first webpage;
determine meta information from the one or more second webpages based on the received one or more indications, the meta information being determined based at least in part on an analysis of the one or more second web pages;
determine one or more keywords or categories associated with the point of interest based on the determined meta information; and
determine one or more offerings based on the keywords or categories, and provide the one or more offerings for display in connection with the display of the first webpage;
wherein the one or more offerings are determined based at least in part on a weight assigned to the meta information, the weight being determined based at least in part on an amount of internet traffic associated with the one or more second webpages.
